(19) United States
(12) Patent Application Publication
(10) Pub. No.: US 2020/0083619 A1
(43) Pub. Date: Mar. 12, 2020

(54) TERMINAL UNIT FOR COAXIAL CABLE

(71) Applicant: YAZAKI CORPORATION, Tokyo (JP)

(72) Inventor: Kouichirou Matsushita, Shizuoka (JP)

(21) Appl. No.: 16/529,674

(22) Filed: Aug. 1, 2019

(30) Foreign Application Priority Data
Sep. 6, 2018 (JP) 2018-167041

(51) Int. Cl. H01R 9/05

(52) U.S. Cl. CPC H01R 9/0518

(57) ABSTRACT

A terminal unit for a coaxial cable provided in a terminal portion of a coaxial cable includes an outer conductor terminal and a cylindrical sleeve. The sleeve is crimped to the coaxial cable together with an outer conductor by the outer conductor terminal. The outer conductor is sandwiched between the outer conductor crimping portion and the sleeve in a state of being wound around the sleeve so as to go around an outer peripheral surface of the sleeve. The sleeve has a spiral uneven structure on the outer peripheral surface thereof.

### CROSS-REFERENCE TO RELATED APPLICATIONS

This application is based on and claims priority under 35 USC 119 from Japanese Patent Application No. 2018-167041 filed on Sep. 6, 2018, the contents of which are incorporated herein by reference.

### TECHNICAL FIELD

The present invention relates to a terminal unit for a coaxial cable.

### BACKGROUND ART

Conventionally, there is known a terminal unit for a coaxial cable including an outer conductor terminal having a connection portion with a mating terminal on a distal end side and an outer conductor crimping portion on the proximal end side that crimps an outer conductor (for example, a braided member) provided in a concentric cylindrical shape around the axis of the coaxial cable, and a tubular sleeve provided so as to sandwich the outer conductor of the coaxial cable therebetween (see, for example, Patent Literature 1).

### CITATION LIST

### Patent Literature

Patent Literature 1: JP-A-2005-197066

### SUMMARY OF INVENTION

In the terminal unit as described above, the outer conductor (for example, a braided member) of the coaxial cable is normally crimped by the outer conductor crimping portion of the outer conductor terminal to be held by the outer conductor crimping portion. However, for example, in the crimping process, the outer conductor may be unevenly distributed in the periphery direction of the coaxial cable due to the slip of the outer conductor, the deformation of the sleeve, or the like. In this case, depending on the degree of deviation of the outer conductor, there is a possibility that the outer conductor is insufficiently held by the outer conductor crimping portion. If the outer conductor is insufficiently held, the outer conductor may be displaced with respect to the outer conductor crimping portion when an external force such as a tensile force acts on the coaxial cable. If excessive displacement of the outer conductor occurs, the reliability of the electrical connection between the outer conductor and the outer conductor crimping portion (in other words, the coaxial cable and the outer conductor terminal) may decrease.

Although it is conceivable to increase the force of crimping the outer conductor crimping portion as a countermeasure, when the force is excessively increased, there is a possibility that the thickness and shape of a dielectric layer constituting the coaxial cable (usually the coaxial cable has a concentric multilayer structure including an inner conductor, a dielectric layer, an outer conductor, or the like.) may be changed. The thickness and shape of the dielectric layer can affect the impedance characteristics of the coaxial cable. Therefore, it is not preferable that a force for crimping the outer conductor crimping portion is unnecessarily increased.

Therefore, it is desired to suppress the deviation of the outer conductor in the periphery direction of the coaxial wire at the time of crimping without excessively increasing the force of crimping the outer conductor crimping portion, and thus to improve the reliability of the electrical connection between the outer conductor and the outer conductor crimping portion.

The present invention has been made in view of the above circumstances, and an object thereof is to provide a terminal unit for a coaxial cable that is capable of maintaining the reliability of good electrical connection by suppressing the deviation of the outer conductor.

In order to achieve the above object, the terminal unit for a coaxial cable according to the present invention is characterized by the following [1] to [2].
[1] A terminal unit for a coaxial cable provided in a coaxial cable having an inner conductor and an outer conductor disposed on a concentric cylinder around the inner conductor, the terminal unit for the coaxial cable includes: an outer conductor terminal having an outer conductor crimping portion on a proximal end side so as to crimp the outer conductor and having a connection portion with a mating terminal on a distal end side; and a crimping accessory crimped together with the outer conductor by the outer conductor crimping portion. The outer conductor is sandwiched between the outer conductor crimping portion and the crimping accessory in a state of being wound around the crimping accessory so as to go around an outer peripheral surface of the crimping accessory.
[2] In the terminal unit for the coaxial cable according to the above structure [1], the crimping accessory has a spiral uneven structure on the outer peripheral surface of the crimping accessory. The outer conductor is wound around the crimping accessory so as to spirally go around the outer peripheral surface of the crimping accessory along the uneven structure

According to the terminal unit with the configuration of [1], the outer conductor crimping portion is crimped to the outer conductor in a state in which the outer conductor (for example, the braided member) is wound around the crimping accessory so as to go around the outer peripheral surface of the crimping accessory between the outer conductor crimping portion and the crimping accessory (for example, a sleeve). Therefore, as compared with the case where crimping is performed with the outer conductor simply covered with the crimping accessory as in the above-described conventional terminal unit, the distribution of the outer conductor in the periphery direction of the crimping accessory can be positively adjusted, and the deviation of the outer conductor can be suppressed without excessively increasing the force for crimping the outer conductor crimping portion. The winding of the outer conductor can be realized, for example, by a method such as winding the outer conductor into a thin string and then winding the outer conductor around the crimping accessory. By performing crimping in a state where the outer conductor is wound around the crimping accessory, excessive displacement of the outer conductor is unlikely to occur, and the reliability of the good electrical connection between the outer conductor and the outer conductor crimping portion (in other words, the coaxial wire and the outer conductor terminal) can be maintained even when an external force such as a tensile force acts on the coaxial cable.

According to the terminal unit with the configuration of [2], the outer conductor (for example, the braided member) is wound around the crimping accessory along the spiral uneven structure provided on the outer peripheral surface of the crimping accessory (for example, the sleeve). Thus, the distribution of the outer conductor in the axial direction can be actively adjusted in addition to the periphery direction of the crimping accessory, and the deviation of the outer conductor on the outer peripheral surface of the crimping accessory can be further appropriately suppressed.

According to the present invention, it is possible to provide a terminal unit for a coaxial cable capable of maintaining the reliability of good electrical connection.

The present invention has been briefly described above. Further, details of the present invention will be clarified by reading a mode for carrying out the invention (hereinafter, referred to as “embodiments”) described below with reference to the accompanying drawings.

### BRIEF DESCRIPTION OF DRAWINGS

FIG. 1 is a perspective view showing a structure of a terminal unit for a coaxial cable according to the present embodiment;

FIGS. 2A to 2C are schematic views illustrating a procedure of winding a braided member on an outer peripheral surface of a sleeve in the terminal unit shown in FIG. 1;

FIG. 3A is a side view of the terminal unit shown in FIG. 1, and FIG. 3B is a cross-sectional view taken along line A-A in FIG. 3A; and

FIG. 4A is an enlarged view of a portion B in FIG. 3B, and FIG. 4B is a schematic view of a portion shown in FIG. 4A when viewed from an axial direction of the terminal unit.

### DESCRIPTION OF EMBODIMENTS

### <Embodiment>

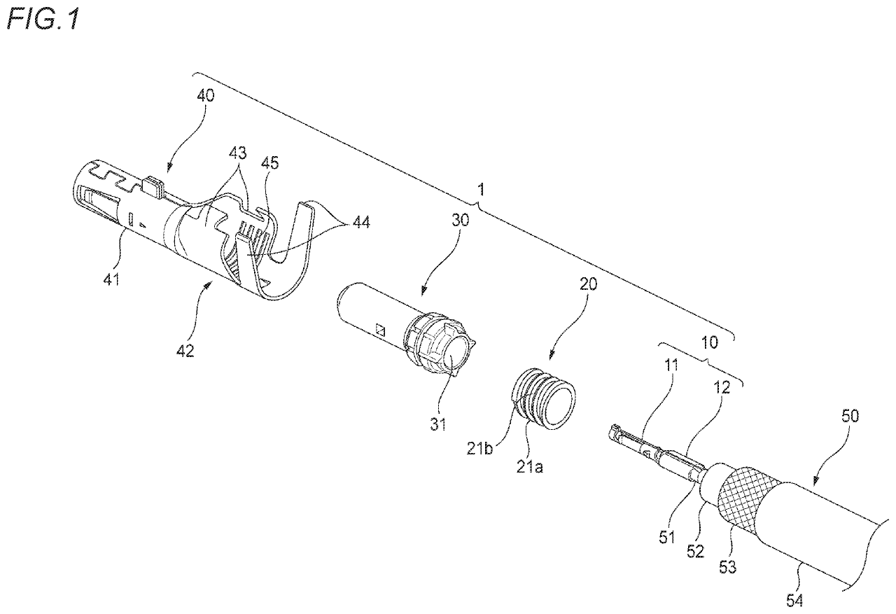

Hereinafter, a terminal unit 1 for a coaxial cable according to an embodiment of the present invention will be described with reference to the drawings. Further, for convenience of description, a side (left side in FIGS. 1 to 3) on which a mating terminal (not shown) fitted in the axial direction of the terminal unit 1 is referred to as a distal end side (front side), and the opposite side (right side in FIGS. 1 to 3) is referred to as a proximal end side (rear side).

### <Configuration of Terminal Unit>

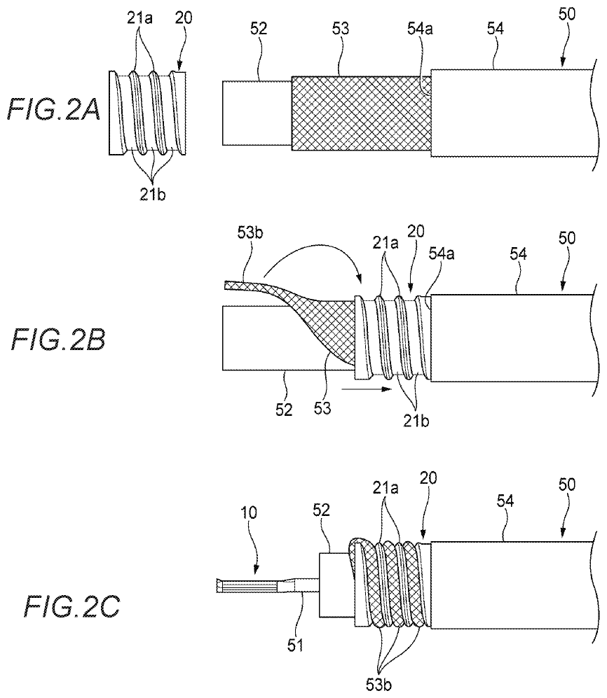

As shown in FIGS. 1 to 4B, the terminal unit for a coaxial cable 1 includes an inner conductor terminal 10, a sleeve 20, a dielectric 30 (in other words, a housing of the inner conductor terminal 10), and an outer conductor terminal 40 (in particular, see FIG. 2). As shown in FIG. 1, the terminal unit 1 is connected to an end portion of the coaxial cable 50 and accommodated in a terminal accommodating chamber (not shown) of a connector housing (not shown). Further, in this example, the sleeve 20 corresponds to a “crimping accessory”.

As shown in FIG. 1, the coaxial cable 50 includes a linear inner conductor 51, a dielectric layer 52 made of a cylindrical dielectric covering the outer periphery of the inner conductor 51, a cylindrical outer conductor (braided member) 53 covering the outer periphery of the dielectric layer 52, and a cylindrical resin sheath 54 covering the outer periphery of the outer conductor 53. The dielectric layer 52 is generally used for the purpose of adjusting the impedance characteristics of the coaxial cable 50. When the coaxial cable 50 is connected to the terminal unit 1, the inner conductor 51 and the outer conductor 53 of the coaxial cable 50 are exposed to the outside in advance by performing a predetermined terminal process. Hereinafter, each component constituting the terminal unit 1 will be described in order.

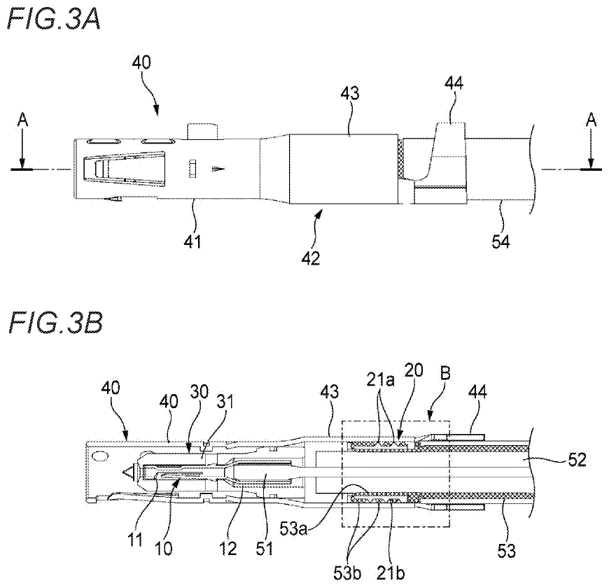

First, the inner conductor terminal 10 will be described. As shown in FIGS. 1 and 3B, the inner conductor terminal 10 has a function of being connected to a mating terminal (not shown) and being conductively connected to the inner conductor 51 of the coaxial cable The inner conductor terminal 10 is made of metal. Further the inner conductor terminal 10 integrally includes a cylindrical connection portion 11 which is located at the distal end portion thereof and is connected to the mating terminal, and a crimping portion 12 which is positioned art the proximal end portion and configured by a pair of crimping pieces for crimping the inner conductor 51 of the coaxial cable 50. A mating terminal (male terminal) is inserted into a hollow portion (through hole) of the connection portion 11.

Next, the sleeve 20 will be described. As shown in FIGS. 1, 3A, 3B, 4A and 4B, the sleeve 20 is made of metal, and is disposed around the terminal portion of the outer conductor 53 of the coaxial wire 50 Further, the sleeve 20 has a function of reinforcing the terminal portion of the outer conductor 53 to increase the crimping force to the outer conductor 53 by the outer conductor terminal 40. Specifically, as shown in FIGS. 2A to 2C, the sleeve 20 has a spiral uneven structure formed by a spiral convex portion 21a and a spiral concave portion 21b on the outer peripheral surface thereof. A distal end surface of the sleeve 20 is inserted and fixed to the outer periphery of the outer conductor 53 so as to be positioned on the proximal end side by a predetermined distance from the distal end of the outer conductor 53 exposed to the outside, and thereafter, a portion of the outer conductor 53 positioned on the proximal end side of the sleeve 20 is wound around the outer peripheral surface of the sleeve 20. More details will be described later.

Hereinafter, for convenience of description, a portion of the outer conductor 53 wound around the sleeve 20 may be referred to as an “outer conductor winding portion 53b”, and a portion other than the “outer conductor winding portion 53b” of the outer conductor 53 may be referred to as an “outer conductor main body portion 53a”.

Next, the dielectric 30 (the housing of the inner conductor terminal 10) will be described. As shown in FIGS. 1, 3A and 3B, the dielectric 30 has a function of accommodating and holding the connection portion 11 of the inner conductor terminal 10 and being accommodated and held in the outer conductor terminal 40 so as to insulate the inner conductor terminal 10 and the outer conductor terminal 40 from each other. As shown in FIGS. 2A to 3B, the dielectric 30 is made of an insulating synthetic resin having a predetermined dielectric constant, and has a substantially cylindrical shape. The hollow portion (through hole) of the dielectric 30 functions as a terminal accommodating chamber 31 that accommodates and holds the connection portion 11 of the inner conductor terminal 10 (in particular, see FIGS. 3A and 3B).

Next, the outer conductor terminal 40 will be described. As shown in FIGS. 1, 3A and 39, the outer conductor terminal 40 has functions of being connected to a mating terminal (not shown) to accommodate and hold the dielectric 30 and being conductively connected to the outer conductor 53 of the coaxial cable 50. The outer conductor terminal 40 is made of metal. Further, the outer conductor terminal 40 integrally includes a cylindrical shell portion 41 that is positioned at the distal end portion thereof and is connected to the mating terminal and accommodates the dielectric 30, and an outer conductor crimping portion 42 positioned at the proximal end portion thereof and for crimping the outer conductor 53 of the coaxial cable 50.

A mating terminal (male terminal) is inserted into the opening on the distal end side of the shell portion 41. The outer conductor crimping portion 42 includes a pair of crimping pieces 43 positioned on the distal end side and for crimping the outer conductor 53 of the coaxial cable 50, and a pair of crimping pieces 44 positioned on the proximal end side and for crimping the sheath 54 of the coaxial cable 50. A plurality of ridges 45 extending in the width direction are formed at predetermined intervals in the axial direction on an inner peripheral surface of a coupling portion (bottom plate portion and side plate portion) that connects root portions of the pair of crimping pieces 43 in the outer conductor crimping portion 42.

The components constituting the terminal unit 1 shown in FIG. 1 have been described above. When the terminal unit 1 is assembled, first, as described above, the sleeve 20 is inserted and fixed to the outer conductor main body 53a of the coaxial cable 50, and the outer conductor winding portion 53b is wound around the outer periphery of the sleeve 20.

Specifically, first, as shown in FIG. 2A, the distal end portion of the sheath 54 is removed (peeled) such that the outer conductor 53 is exposed to the outside of the coaxial cable 50. Next, as shown in FIG. 23, the sleeve 20 is inserted into the proximal end side (right side in FIG. 2) of the coaxial cable 50 such that the outer conductor 53 passes through the hollow portion of the sleeve 20. The sleeve 20 is inserted until the sleeve abuts the end surface 54a of the sheath 54. Then, the outer conductor 53 exposed on the distal end side of the sleeve 20 is bundled into a thin string to form the outer conductor winding portion 53b. Then, as shown in FIG. 2C, the outer conductor winding portion 53b is spirally wound so as to be disposed on the spiral concave portion 21b while being guided along the spiral convex portion 21a of the sleeve 20. As a result, the outer conductor winding portion 53b is spirally wound on the outer peripheral surface of the sleeve 20. Although not related to the winding of the outer conductor 53, in FIG. 2C, after the outer conductor 53 is wound, the inner conductor terminal 10 is connected to the inner conductor 51 exposed from the distal end of the dielectric layer 52.

Next, the connection portion 11 of the inner conductor terminal 10 is accommodated and held in the terminal accommodating chamber 31 of the dielectric 30. Then, as shown in FIG. 3B, the dielectric 30 is accommodated and held in the shell portion 41 of the outer conductor terminal 40 while the connection portion 11 is held in the dielectric 30. Thus, a portion where the outer conductor winding portion 53b of the outer conductor 53 of the coaxial cable 50 is positioned (that is, a portion where the sleeve 20 is positioned) is placed on the inner peripheral surface (that is, the inner peripheral surface on which the plurality of ridges 45 are formed) of the coupling portion (bottom plate portion and side plate portion) of the outer conductor crimping portion 42.

Next, using the pair of crimping pieces 43 and the pair of crimping pieces 44 in the outer conductor crimping portion 42, the outer conductor winding portion 53b (in other words, the sleeve 20) and the sheath 54 of the coaxial cable 50 are crimped and fixed, respectively. Thus, the assembly of the terminal unit 1 is completed.

### <Crimping Structure Configured by Opposing Surfaces of Outer Conductor Crimping Portion and Sleeve>

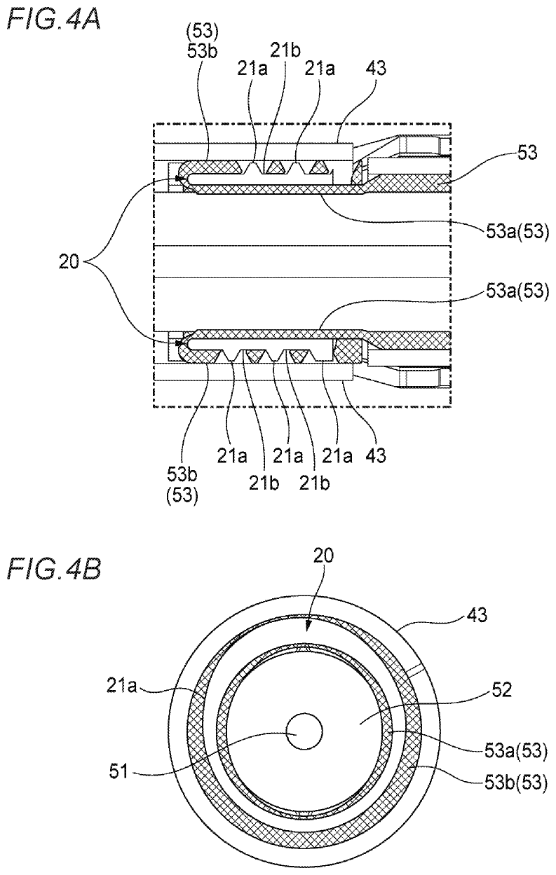

When the outer conductor winding portion 53b (in other words, the sleeve 20) of the coaxial cable 50 is crimped and fixed by using the pair of crimping pieces 43 of the outer conductor crimping portion 42 of the outer conductor terminal 40 is crimped and fixed, as shown in FIGS. 4A and 4B, the outer conductor winding portion 53b is sandwiched between the outer peripheral surface of the sleeve 20 and the inner peripheral surface of the outer conductor crimping portion 42 (coupling portion of the outer conductor crimping portion 42).

As described above, the spiral convex portion 21a and the spiral concave portion 21b form a spiral uneven structure on the outer peripheral surface of the sleeve 20, and the outer conductor winding portion 53b is disposed along the uneven structure. In FIGS. 4A and 4B, for convenience of description, voids exist between the spiral convex portion 21a and the spiral concave portion 21b, the outer conductor winding portion 53b, and the outer conductor crimping portion 42. In practice, the outer conductor winding portion 53b substantially fills the void by crushing of the protruding end of the spiral convex portion 21a, deformation of the outer conductor winding portion 53b, or the like in the process of crimping the outer conductor crimping portion 42 to the coaxial cable 50. Thus, sufficient electrical connection between the outer conductor crimping portion 42 and the outer conductor 53 is achieved.

Further, the reliability of the electrical connection between the outer conductor crimping portion 42 and the outer conductor 53 can be further improved as long as the plurality of ridges 45 provided on the inner peripheral surface of the outer conductor crimping portion 42 and the spiral uneven structure can be fitted to each other.

As described above, according to the terminal unit 1 of the embodiment of the present invention, the outer conductor crimping portion 42 is crimped to the outer conductor winding portion 53b in a state in which the outer conductor winding portion 53b is wound around the spiral uneven structure formed by the spiral convex portion 21a and the spiral concave portion 21b provided on the outer peripheral surface of the sleeve 20. Therefore, when the outer conductor winding portion 53b meshes with the uneven structure, the contact area between the outer conductor winding portion 53b and the outer conductor crimping portion 42 increases, and the outer conductor winding portion 53b can be firmly held with respect to the outer conductor crimping portion 42. As a result, even when an external force such as a tensile force acts on the coaxial cable 50, excessive displacement of the outer conductor 53 is unlikely to occur, and the reliability of good electrical connection between the outer conductor 53 and the outer conductor crimping portion 42 (in other words, the coaxial cable 50 and the outer conductor terminal 40) can be maintained.

### <Other Embodiments>

The present invention is not limited to the above embodiments, and various modifications can be adopted within the scope of the present invention. For example, the present invention is not limited to the embodiments described above, and may be appropriately modified, improved, or the like. In addition, materials, shapes, dimensions, numbers, disposition locations, or the like of constituent elements in the above-described embodiments are arbitrary and are not limited as long as the present invention can be achieved.

Further, characteristics of the embodiments of the terminal unit 1 according to the present invention described above are summarized briefly in the following [1] to [2], respectively.
[1] A terminal unit 1 for a coaxial cable provided in a coaxial cable 50 having an inner conductor 51 and an outer conductor 53 disposed on a concentric cylinder around the inner conductor 51, the terminal for the coaxial cable including:

an outer conductor terminal 40 having an outer conductor crimping portion 42 on a proximal end side that crimps the outer conductor 53 and having a connection portion 41 with a mating terminal on a distal end side; and

a crimping accessory 20 crimped together with the outer conductor 53 by the outer conductor crimping portion 42,

in which the outer conductor 53 is sandwiched between the outer conductor crimping portion 42 and the crimping accessory 20 in a state of being wound around the crimping accessory 20 so as to go around an outer peripheral surface of the crimping accessory 20.
[2] The terminal unit 1 for a coaxial according to [1]3

in which the crimping accessory 20 has a spiral uneven structure 21a, 21b on an outer peripheral surface of the crimping accessory 20, and

in which the outer conductor 53 is wound around the crimping accessory 20 so as to spirally go around the outer peripheral surface of the crimping accessory 20 along the uneven structures 21a, 21b.

What is claimed is:

1. A terminal unit for a coaxial cable provided in a coaxial cable having an inner conductor and an outer conductor disposed on a concentric cylinder around the inner conductor, the terminal unit for the coaxial cable comprising:
an outer conductor terminal having an outer conductor crimping portion on a proximal end side so as to crimp the outer conductor and having a connection portion with a mating terminal on a distal end side; and
a crimping accessory crimped together with the outer conductor by the outer conductor crimping portion,
wherein the outer conductor is sandwiched between the outer conductor crimping portion and the crimping accessory in a state of being wound around the crimping accessory so as to go around an outer peripheral surface of the crimping accessory.

2. The terminal unit for the coaxial cable according to claim 1, wherein
the crimping accessory has a spiral uneven structure on the outer peripheral surface of the crimping accessory, and
the outer conductor is wound around the crimping accessory so as to spirally go around the outer peripheral surface of the crimping accessory along the uneven structure.
